(19) United States
(12) Patent Application Publication
(10) Pub. No.: US 2012/0138542 A1
(43) Pub. Date: Jun. 7, 2012

(54) PROCESS FOR IMPROVING INLINE TAILINGS TREATMENT

(75) Inventors: Trong DANG-VU, Edmonton (CA); Phil CAGLE, Lakeland, FL (US)

(73) Assignees: S.P.C.M. SA, ANDREZIEUX BOUTHEON (FR); SNF HOLDING COMPANY, Riceboro, GA (US)

(21) Appl. No.: 13/290,564

(22) Filed: Nov. 7, 2011

Related U.S. Application Data
(60) Provisional application No. 61/419,094, filed on Dec. 2, 2010.

(51) Int. Cl. B01D 21/01

(52) U.S. Cl. 210/723

(57) ABSTRACT

A process for improving inline mineral slurries treatment comprises successively: providing an in-line flow of slurries in a main stream; introducing at least one polymer into the main stream through at least one polymer injection point to cause dispersion of the polymer and to start the coagulation and/or the flocculation of slurries to produce treated slurries; and splitting the main stream containing treated slurries into two streams respectively: a discharge stream which directly transfers a part of treated slurries to the deposit area, and a split stream which reintroduces the other part of treated slurries into the main stream through at least a reinjection point in a location prior to the at least one polymer injection point.

### TECHNICAL FIELD

The present invention relates to the treatment of material comprising an aqueous liquid with dispersed particulate solids.

The invention relates to a process for improving the inline treatment process of slurries or tailings resulting from mineral processing.

### BACKGROUND OF THE ART

Treatment of tailings and other waste material have become a technical, environmental and public policy issue.

Mineral processes produce a huge quantity of waste material slurries or tailings which can be in aqueous suspension with dispersed particulate solids, for instance sand, clay, shale and other minerals. It has been and still is a sizable issue for the mining industry to treat these tailings and accomplish liquid solid separation at the processes end to separate liquid from the solid.

It is common practice to use synthetic or natural polymers such as coagulants and flocculants to separate the solids from the liquid.

Inline flocculation is a well-known process in which a polymer is injected into a flow of slurry feed that uses the pipeline flow to mix and treat the material.

There is a need to improve the inline treatment of tailings process, and especially to improve the efficiency of the polymer.

### DESCRIPTION OF THE INVENTION

The present invention responds to the above need by providing a process for improving the treatment of tailings with polymer.

Accordingly, the invention provides a process comprising providing an in-line flow of the tailings; introducing a polymer into the in-line flow of the tailings to cause dispersion of the polymer and to start the coagulation and/or the flocculation of the tailings; splitting away a part of the treated tailings; returning via a pipeline this part of the treated tailings into the initial in-line flow at a location prior to the polymer injection. The treated tailings is then transferred and disposed to a deposition area to allow more separation to occur between the liquids and solids.

This process creates a more efficient reaction between the polymer and tailings that increases the drainage, water release and general dewatering of the tailings. The process also improves the clarity of the released liquor that allows the clarified water to be reused and made immediately available for recirculation to the plant. The treated tailings solidify much faster, resulting in a more stable fill. The treated tailings can form a layer material of dried rigid and solid enough to support the weight of a vehicle. This approach should allow the industry to show its concern for the environment by minimising the allocation of new land for disposal purposes and to more efficiently use the existing waste areas its been granted.

Therefore, the object of the invention is a process for improving inline mineral slurries treatment comprising successively:
providing an in-line flow of slurries in a main stream;
introducing at least one polymer into the main stream through at least a polymer injection point to cause dispersion of the polymer and to start the coagulation and/or the flocculation of slurries (treated slurries);
splitting the main stream containing treated slurries into two streams respectively:
   a discharge stream which directly transfers a part of treated slurries to the deposit area,
   a split stream which reintroduces the other part of treated slurries into the main stream through at least a reinjection point in a location prior to the at least one polymer injection point.

The initial in-line flow also called “main stream” is preferably more than 5 m³/h and generally comprised between 50 to 1,000 m³/h but is not limited depending of the material used. The percentage of split stream is defined as the percent of treated feed flow which is split away and reintroduced into the initial in-line flow. It' a ratio of a split flow (m³/h) to an initial in-line flow (m³/h) and is expressed in percentage.

The percentage of split stream is comprised between 5 to 95%, preferably less than 75% more preferably less than 50%.

One or more static mixer could be added in the process to improve the efficiency of the treatment. Static mixer could be added in main stream between the reinjection point and the polymer injection point, and/or after the polymer injection point, and/or in the split stream and/or in the main stream before the reinjection point.

One embodiment to easily improve the performances is to add a static mixer between the reinjection point, where the treated tailings is reintroduced in the initial in-line flow, and the polymer injection point.

The types of polymers suitable for the process of the invention may broadly include any type of water-soluble or water swell able polymer, including natural, semi-natural and synthetic polymers.

The process enables a wide variety of organic polymers which need to be selected depending for example of the nature of the tailings, their solids concentration, and other parameters well-known by the skilled man of the art.

The natural polymer may be for instance polysaccharides such as dextran, starch or guar gum. The semi-natural polymer may be carboxymethyl cellulose.

Synthetic polymers are preferred and can be coagulant, but preferably flocculant.

Particularly suitable water soluble or water swellable polymers are based on acrylamide. They can be cationic, anionic, non-ionic or amphoteric polymer.

Practically, the polymer can be made by the polymerisation of:

a) one or more non-ionic monomer selected from the group comprising (meth)acrylamide, (meth)acrylic, vinyl, allyl or maleic backbone and having a polar non-ionic side group: mention can be made in particular, and without this being limitation, of acrylamide, methacrylamide, N-vinyl pyrrolidone, N-vinyl formamide, N,N dimethylacrylamide, N-vinyl acetamide, N-vinylpyridine, N-vinylimidazole, isopropyl acrylamide and polyethelene glycol methacrylate

and/or

b) one or more anionic monomer(s) comprising (meth)acrylic, vinyl, allyl or maleic backbone, mention can be made in particular, and without this being limitation, of monomers having a carboxylic function (e.g.: acrylic acid, methacrylic acid and salts thereof), or having a sulphonic acid function (e.g.: 2-acrylamido-2-methylpropane sulphonic acid (ATBS) and salts thereof).

and/or

c) one or more cationic monomer(s) comprising (meth)acrylamide, (meth)acrylic, vinyl, allyl or maleic backbone and having an amine or quaternary ammonium function, mention can be made in particular, and without this being limitation, of quaternized or salified dimethylaminoethyl acrylate (ADAME) and/or dimethylaminoethyl methacrylate (MADAME) ; dimethyldiallylammonium chloride (DADMAC), acrylamido propyltrimethyl ammonium chloride (APTAC) and/or methacrylamido propyltrimethyl ammonium chloride (MAPTAC).

The polymer could contain one or more monomers having a hydrophobic character. Hydrophobic monomer are preferably selected from the group including (meth)acrylic acid esters with an alkyl, arylalkyl and/or ethoxylated chain, derivates of (met)acrylamide with an alkyl, arylalkyl or dialkyl chain, cationic allyl derivates, anionic or cationic hydrophobic (meth)acryloyl derivates, or anionic and/or cationic monomers derivates of (meth)acrylamide bearing a hydrophobic chain.

Particularly preferred polymer are anionic and formed from monomers selected from ethylenically unsaturated carboxylic acid and sulfonic acid monomers, preferably selected from (meth) acrylic acid and/or 2-Acrylamido-2-methylpropane sulfonic acid, and their salts, combined with non-ionic co-monomers, preferably selected from (meth) acrylamide, N-vinyl pyrrolidone.

Preferred anionicity is comprised between 10 and 40 mol %.

The molecular weight of the ionic polymer is between 100,000 g/mol and 20 million, preferably more than 1 million g/mol.

The polymer could be linear, branched or crosslinked. Branching or crosslinking agents are selected from the group comprising methylene bisacrylamide (MBA), ethylene glycol diacrylate, polyethylene glycol dimethacrylate, diacrylamide, cyanomethylacrylate, vinyloxyethylacrylate or methacrylate, triallylamine, formaldehyde, glyoxal, compounds of the glycidylether type such as ethyleneglycol diglycidylether, or epoxy.

According to the invention, water-soluble polymers do not require the development of a particular polymerization method. They can be obtained by all polymerization techniques well known by a person skilled in the art : solution polymerization, suspension polymerization, gel polymerization, precipitation polymerization, emulsion polymerization (aqueous or reverse) followed or not by spray drying step, suspension polymerization, micellar polymerization followed or not by a precipitation step.

The polymer is added in liquid form or in solid form in the in-line flow of the tailings at the polymer injection point. The polymer can be added as an emulsion (water in oil or oil in water), a solution, a powder, or bead.

The polymer is preferably added in an aqueous solution. If the polymer is in a solid form, it could be partially or totally dissolved in water with the Polymer Slicing Unit (PSU) disclosed in WO 2008/107492 (the full contents of which is hereby incorporated by reference herein).

According to the invention, the dosage of the polymer added in the in-line flow is between 50 and 5,000 g per tonne of dry solids of mineral slurries, preferably between 250 and 2,000 g/t, and more preferably between 500 and 1,500 g/t, depending on the nature and the composition of the tailings to be treated.

According to a specific embodiment, one or more polymers could be added in the main stream, separately or simultaneously and the polymers could be injected, advantageously in two or more injection points into the in-line flow.

The process of the invention is suitable for treating aqueous mineral slurries of particulate solids. Mineral slurries result from the processing of minerals which includes ore beneficiation and the extraction of minerals. Minerals broadly include ores, natural substances, inorganics, mixtures of inorganic substances and organic derivatives such as coal.

The tailings can contain any amount of suspended particulate solids. Typical slurries include but are not limited to aqueous tailings or mineral slurries obtained from a gold ore, platinum ore, nickel ore, coal ore, copper ore, or an ore-body from a diamond mine, or phosphate or gold tailings.

The process can be used in the treatment of red mud from the Bayer alumina process, preferably red mud from a washer or final thickener of a Bayer process.

The process is particularly suitable for treatment of tailings resulting of the oil sands extraction, especially Mature Fine Tailings (MFT) which are specific because of the large proportion of fine solid particles, less than 44 microns. MFT are difficult to dewater and to solidify.

The process can be used for different post process applications such as beach drying, centrifugation, mine cut filling, screw press, etc.

### BRIEF DESCRIPTION OF THE DRAWING FIGURES

FIG. 1 is an illustration of an installation of the invention involving the process of the invention according to a first embodiment.

FIG. 2 is an illustration of an installation of the invention involving the process of the invention according to a second embodiment.

FIG. 3 is a representation of gravity drainage at different percentages of split stream in a mature fine tailings dewatering process.

FIG. 4 is a representation of the effect of split stream on 90 minute net water release in a mature fine tailings dewatering process.

FIG. 5 is a representation of the effect of split stream on 120-second drainage without split stream and with split stream in a phosphate tailings dewatering process.

### DETAILED DESCRIPTION

### Example 1

### Split Stream Process Model 1

FIG. 1 is a scheme illustrating a first embodiment of the installation of the invention. Accordingly, the installation comprises a main stream (1) within which circulates an in-line flow of slurries (2). The main stream contains a polymer injection point (3) through which at least one polymer is injected. The main stream is then divided into two streams respectively:
a discharge stream (4) which directly transfers a part of treated slurries to the deposit area (5),
a split stream (6) which reintroduces the other part of treated slurries into the main stream (1) through the reinjection point (7) prior to the polymer injection point (3). As shown on the scheme, the installation is also equipped with a static mixer (8).

### Example 2

### Split Stream Process Model 2

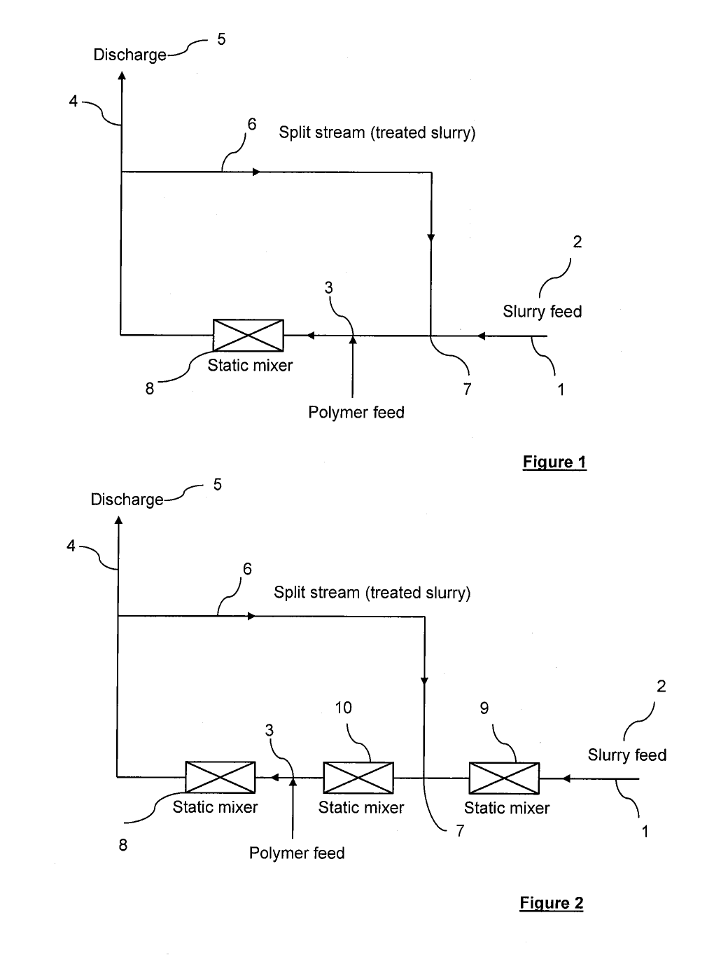

FIG. 2 is a scheme illustrating a second embodiment of the installation of the invention. This installation differs from the first one in that it contains two additional static mixers. The second static mixer (9) is located before the reinjection point (7) and the third one is located between the reinjection point (7) and the injection point (3).

### Examples 3

### Effect of Split Stream on Mature Fine Tailings Dewatering

### Test Procedure

200 g of oil sands mature fine tailings of 48.9% solids was mixed with the desired volume of 0.2 wt % solution of A-3338. After mixing, a known percentage of slurry was collected (subsampled) and additional untreated MFT and polymer solution were added into it. More mixing was applied to achieve the optimal flocculation. The additional untreated MFT and polymer were added in amounts so that a total MFT used was 200 g and final polymer dosage was unchanged for all tests. Because the final amount of treated MFT was the same with the initial MFT (200 g), the percentage of collected slurry was defined as a percentage of split stream.

After flocculation, a gravity drainage test was performed and net water release was also determined at 90 minutes.

### Results

As shown in FIG. 3, split stream increased significantly drainage rate. The highest drainage rate was obtained for 12.5% of split stream.

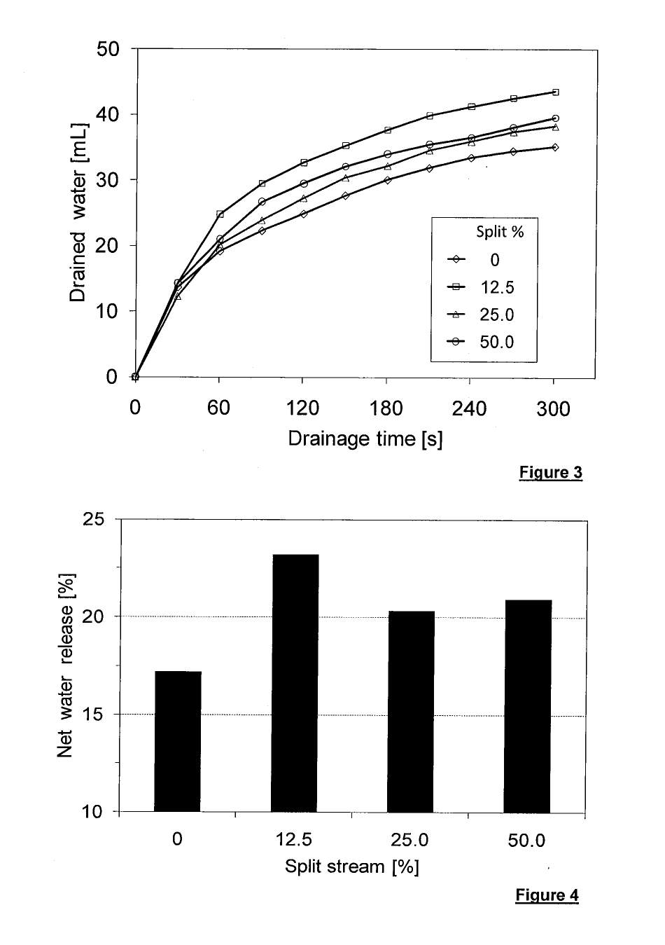

As shown in FIG. 4, split stream increased 90-minute net water release from 17% to 23%.

### CONCLUSION

The split stream improved drainage of flocculated MFT.

### Example 4

### Effect of Split Stream on Phosphate Tailings Dewatering

### Test Procedure

Two tests were conducted to study the effects split streaming has on phosphate tailings dewatering. In the first test conducted without the split stream, a 200 mL phosphate tailings sample at 8.8% solids was mixed with 12 mL of EM 533 (an anionic polymer solution). After mixing, the flocculated slurry was then poured into a sieve and a volume of the drained water was measured. In the second test with the split stream, a 50 ml sample of phosphate tailings was mixed with 3 mL of EM 533 solution. After mixing, an additional 150 mL of phosphate tailings and 9 mL of EM 533 solution was added to the original 50 ml mixture and further mixing was then applied. The flocculated material was then poured into a sieve and a measurement of the drained water was taken.

### CONCLUSION

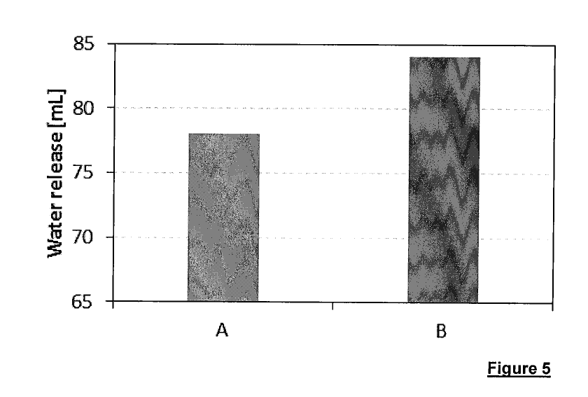

As shown in FIG. 5, the split stream improved drainage of flocculated tailings.

1. A process for improving inline mineral slurries treatment comprising successively:
providing an in-line flow of slurries in a main stream;
introducing at least one polymer into the main stream through at least one polymer injection point to cause dispersion of the polymer and to start coagulation and/or flocculation of the slurries to produce treated slurries; and
splitting the main stream containing treated slurries into two streams respectively:
a discharge stream which directly transfers a first part of the treated slurries to a deposit area, and
a split stream which reintroduces a second part of the treated slurries into the main stream through at least one reinjection point in a location prior to the at least one polymer injection point.

2. The process according to claim 1, wherein the split stream represents between 5 and 95% of the main stream.

3. The process according to claim 1, wherein at least one static mixer is added in the main stream: between the reinjection point and the polymer injection point, and/or after the polymer injection point, and/or in the split stream and/or in the main stream before the reinjection point.

4. The process according to claim 1, wherein at least one static mixer is added in the main stream between the reinjection point and the polymer injection point.

5. The process according to claim 1, wherein the polymer is added into the main stream at a dosage between 50 and 5,000 g per tonne of dry solids of the mineral slurries.

6. The process according to claim 1, wherein the polymer is made by the polymerisation of:
a) one or more non-ionic monomer comprising a (meth)acrylamide, (meth)acrylic, vinyl, allyl or maleic backbone and having a polar non-ionic side group selected from the group consisting of acrylamide, methacrylamide, N-vinyl pyrrolidone, N-vinyl formamide, N,N dimethylacrylamide, N-vinyl acetamide, N-vinylpyridine, N-vinylimidazole, isopropyl acrylamide and polyethelene glycol methacrylate and/or
b) one or more anionic monomer(s) comprising a (meth)acrylic, vinyl, allyl or maleic backbone, selected from the group consisting of monomers having a carboxylic function, or having a sulphonic acid function and/or
c) one or more cationic monomer(s) comprising (meth)acrylamide, a (meth)acrylic, vinyl, allyl or maleic backbone and having an amine or quaternary ammonium function selected from the group consisting of of quaternized or salified dimethylaminoethyl acrylate (ADAME) and/or dimethylaminoethyl methacrylate (MADAME) ; dimethyldiallylammonium chloride (DADMAC), acrylamido propyltrimethyl ammonium chloride (APTAC) and/or methacrylamido propyltrimethyl ammonium chloride (MAPTAC).

7. The process according to claim 6, wherein the polymer includes at least one hydrophobic monomer which is selected from the group including (meth)acrylic acid esters with an alkyl, arylalkyl and/or ethoxylated chain, derivates of (met)acrylamide with an alkyl, arylalkyl or dialkyl chain, cationic allyl derivates, anionic or cationic hydrophobic (meth)acryloyl derivates, or anionic and/or cationic monomers derivates of (meth)acrylamide bearing a hydrophobic chain.

8. The process according to claim 1, wherein the polymer is anionic and prepared from monomers selected from ethylenically unsaturated carboxylic acid and sulfonic acid monomers combined with non-ionic co-monomers.

9. The process according to claim 1, wherein the polymer is ionic and molecular weight of the ionic polymer is between 100 000 g/mol and 20 million.

10. The process according to claim 1, wherein at least two polymers are introduced into the main stream.

11. The process according to claim 10, wherein the at least two polymers are introduced into the main stream separately or simultaneously.

12. The process according to claim 11, wherein the at least two polymers are introduced in two or more injection points into the main stream.

13. The process according to claim 1, wherein the at least one polymer is introduced into the main stream in liquid form or in solid form.

14. The process according to claim 1, wherein the mineral slurries comprise tailings from coal ore, gold ore, platinum ore, nickel ore, copper ore, or an ore-body from a diamond mine, or phosphate or gold tailings.

15. The process according to claim 1, wherein the mineral slurries comprise tailings resulting from an oil sand extraction process.

16. The process according to claim 1, wherein the mineral slurries comprise red muds resulting from a bayer alumina process.

17. The process according to claim 2, wherein the split stream represents less than 75% of the main stream.

18. The process according to claim 2, wherein the split stream represents less than 50% of the main stream.

19. The process according to claim 5, wherein the polymer is added into the main stream at a dosage between 250 to 2,000 g per tonne of dry solids of the mineral slurries.

20. The process according to claim 5, wherein the polymer is added into the main stream at a dosage between 500 to 1,500 g per tonne of dry solids of the mineral slurries.

21. The process according to claim 6, wherein the monomers having a carboxylic function comprise acrylic acid, methacrylic acid and salts thereof and the monomers having a sulphonic acid function comprise 2-acrylamide-2-methylpropane sulphonic acid (ATBS) and salts thereof

22. The process according to claim 8, wherein the polymer is prepared from monomers selected from (meth) acrylic acid and/or 2-Acrylamido-2-methylpropane sulfonic acid, and their salts; and
the non-ionic co-monomers are selected from (meth) acrylamide , N-vinyl pyrrolidone.

23. The process according to claim 9, wherein the molecular weight of the ionic polymer is more than 1 million g/mol.
